(19) United States
(12) Patent Application Publication
(10) Pub. No.: US 2008/0195669 A1
(43) Pub. Date: Aug. 14, 2008

(54) System and method for generating files

(75) Inventor: Chih-Ching Yang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/704,496

(22) Filed: Feb. 8, 2007

(51) Int. Cl. G06F 17/30; G06F 7/00; G06F 17/00

(52) U.S. Cl. 707/200; 707/100; 707/E17.001; 715/230

(57) ABSTRACT

A system and method for generating files are disclosed, which is applicable to an electronic apparatus containing first and second source file data. The first source file data include first annotation data of first component data of a specific object. The second source file data include second annotation data of second component data of the specific object. The method includes obtaining the first annotation data from the first source file data; analyzing whether the second source file data contains similar components data to the first source file data, and if there is found similar data contained in the second source file data; obtaining second annotation data from the second source file data, and if not; generating a specific section of substitute annotation data; and combining the obtained first annotation data and second annotation data or the substitute annotation data in the same setting region and generating final file data.

### FIELD OF THE INVENTION

The present invention relates to data generating techniques, and more particularly, to a file generating system and method capable of associating and combining relevant data in different source file data to automatically generate final file data.

### BACKGROUND OF THE INVENTION

For most electronic products, accompanied user manuals are usually provided by manufacturers as a reference for guiding users on how to operate the electronic products correctly.

Electronic products providing specific functions through execution of software program usually come with a corresponding software user manual and a functional test report. The software user manual is usually composed by personnel according to module codes of the software program, which stores information on individual modules making up the software program and illustrative text information related to each component module. The functional test report is composed by personnel according to test codes of the software program, which stores the functional test report of each component module in the software program. However, the module codes and test codes of the software program are written by engineers from two separate departments, it is difficult to maintain coherency. For example, the software user manual of a software program is independent from its functional test report or that relevant annotations in module codes (test codes) do not match with the software user manual (functional test report) due to human errors.

Accordingly, there is a need for a solution that enhances data accuracy by ensuring coherency between the annotations in the software user manual, the functional test report and the module codes (test codes).

### SUMMARY OF THE INVENTION

In the light of forgoing drawbacks, an objective of the present invention is to provide a file generating method and system for integrating the user manual and testing reports of software and ensuring coherency between the relevant annotations in module codes (test codes) of the software program and the software user manuals and functional test reports, enhancing data accuracy.

Another objective of the present invention is to provide a file generating method and system for reducing human resources and increasing work efficiency.

In accordance with the above and other objectives, the present invention provides a file generating method and system. The file generating method of the present invention is applicable to a data processing device stored with a first source file data and a second source file data, wherein the first source file data is used for storing various first component data of a specific object, each first component data having a corresponding first annotation data, the second source file data for storing various second component data of the specific object, each second component data having a corresponding second annotation data, the method comprising the following steps of: (1) looking up the first component data and extracting the first annotation data corresponding to the first component data; (2) analyzing to see if a second component data exists in the second source file data that corresponds to one of the first component data, if so, proceed to step (3); else, proceed to step (4); (3) extracting the second annotation data from the second source file data corresponding to the second component data, then proceed to step (5); and (4) automatically generating a substitute annotation data for the second component data according to predetermined rules, then proceed to step (5); and (5) combining the first annotation data extracted in step (1) and at least one of the second annotation data extracted in step (3) and the substitute annotation data generated in step (4), thereby generating a final file data.

In one embodiment of the file generating method of present invention, the first source file data and the second source file data further include at least one characteristic keyword for identifying relevant information on the component data of the specific object. In the first and second source file data, the at least one characteristic keyword and the corresponding respective first and second component data and their respective first and second annotation data are placed in the same setting region. The file generating method further comprises searching for the characteristic keyword and extracting information from the setting region in which the characteristic keyword resides, so as to extract the first annotation data of the first component data from the first source file data corresponding to the characteristic keyword, or extract the second annotation data of the second component data from the second source file data corresponding to the characteristic keyword. Moreover, the step (5) combines the first annotation data extracted and at least one of the second annotation data and the substitute annotation data into the same setting region.

The file generating system of the present invention is applicable to a data processing device stored with a first source file data and a second source file data, wherein the first source file data is used for storing various first component data of a specific object, each first component data having a corresponding first annotation data, the second source file data for storing various second component data of the specific object, each second component data having a corresponding second annotation data, the system comprising: a lookup module for looking up the first component data and extracting the first annotation data corresponding to the first component data; an analyzing module for analyzing to see if a second component data exists in the second source file data that corresponds to one of the first component data extracted by the lookup module; a processing module for extracting the second annotation data from the second source file data corresponding to the second component data when the analyzing module determines that the second component data corresponding to the first component data of the first source file data exits in the second source file data and automatically generating a substitute annotation data for the second component data according to predetermined rules when the analyzing module determines that the second component data corresponding to the first component data of the first source file data does not exit in the second source file data; and a combining module for combining the first annotation data extracted by the lookup module and at least one of the second annotation data extracted and the substitute annotation data generated by the processing module, thereby generating a final file data.

In one embodiment of the file generating system of present invention, the first source file data and the second source file data further include at least one characteristic keyword for identifying relevant information on the component data of the specific object. In the first and second source file data, the at least one characteristic keyword and the corresponding respective first and second component data and their respective first and second annotation data are placed in the same setting region. The lookup module searches for the characteristic keyword to extracts information from the setting region in which the characteristic keyword resides, so as to extract the first annotation data of the first component data from the first source file data corresponding to the characteristic keyword. When the analyzing module determines that the second component data corresponding to the first component data in the first source file data exists in the second source file data, the processing module further comprises searching for the characteristic keyword in the setting region in which the second component resides to extract the second annotation data corresponding to the second component data. Moreover, the combining module combines the first annotation data extracted and at least one of the second annotation data and the substitute annotation data into the same setting region.

The file generating method and system of the present invention searches in the first source file data for the characteristic keyword, extracts relevant component data and their first annotation data from the setting region in which the characteristic keyword exists, and analyzes to see if the second source file data has component data corresponding to the first source file data, if so, then extracting the second annotation data in the setting region in which the extracted component resides; else, automatically generating the relevant substitution annotation data, and finally associating and combining the first annotation data and the second annotation data (substation annotation data) of the various components to generate a final file data. This not only ensures coherency between the relevant annotations in module codes (test codes) of the software program and the software user manuals and functional test reports, but also enhances data accuracy and reduces human resources, thus increasing work efficiency.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram of a data processing device having a file generating system according to the present invention; and

FIG. 2 is a flow chart of a file generating method corresponding to the file generating system shown in FIG. 1.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

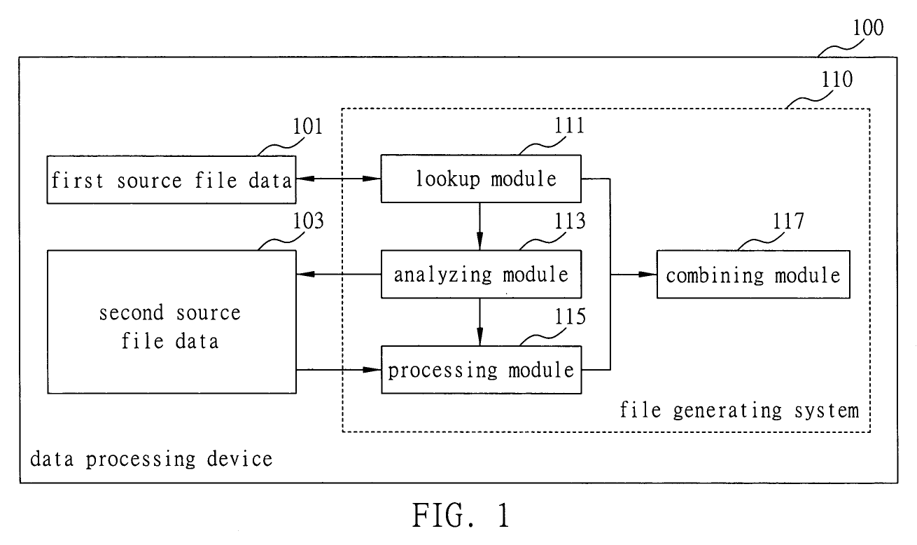

FIG. 1 is a block diagram of a data processing device 100 having a file generating system 110 according to the present invention. The file generating system 110 comprises a lookup module 111, an analyzing module 113, a processing module 115 and a combining module 117. The file generating system 110 is applicable to the data processing device 100, which is stored with first source file data 101 and second source file data 103. The data processing device 100 is an electronic device having a data processing capability. The data processing device 100 can be a server, a personal computer, a notebook, a personal digital assistant, a mobile phone or a multimedia player. The first source file data 101 is used for storing various first component data of a specific object (not shown), each first component data having a corresponding first annotation data. The second source file data 103 is used for storing various second component data of the specific object, each second component data having a corresponding second annotation data. In this embodiment, the specific object is a software program; the first source file data 101 are module codes of the software program, respective component parts of the software program and functional descriptions thereof are stored in the module codes; the second source file data 103 are test codes related to the software program, wherein information such as a functional test report of each component part of the software program is recorded.

Additionally, the abovementioned module codes and test codes further include characteristic keywords for identifying relevant descriptive data of each component within the codes, for example, a characteristic keyword “$description$” is inserted at the beginning of a paragraph. Moreover, in the present invention, characteristic keywords and their corresponding first/second component data and first annotation/second annotation data are placed in the same setting region. For example, the abovementioned relevant data are placed in the same paragraph so that the file generating system 110 of the present invention can automatically identify and extract required information based on the locations of the characteristic keywords in the first source file data 101 and the second source file data 103 (to be discussed later).

The lookup module 111 is used to lookup each first component data related to the specific object in the first source file data 101, and extract first annotation data corresponding to each lookup first component data. More particularly, the lookup module 111 of the present invention first searches for the relevant characteristic keyword “$description$” in the first source file data 101 to obtain the location of the characteristic keyword in the first source file data 101, so as to extract relevant information from the setting region (i.e. paragraph) in which the characteristic keyword is located, thereby extracting the corresponding component information and first annotation data thereof, i.e. the various component module of the software program and their corresponding functional description data.

The analyzing module 113 is used to, based on the various first component data (i.e. various component modules of the software program) extracted from the first source file data 101, analyze whether there is a second component data in the second source file data 103 corresponding to the first component data of the first source file data 101.

The processing module 115 is used to extract a second annotation data corresponding to the second component data from the second source file data 103 if the analyzing module 113 determines that the second component data corresponding to the first component data of the first source file data 101 exists in the second source file data 103, that is, component modules with the same name. More specifically, the processing module 115 searches for characteristic keywords in the paragraphs of the second component data, if one is found, then information within the paragraph in which the characteristic keyword also resides is extracted in order to obtain the second annotation data corresponding to the second component data, for example, a functional test report corresponding to a component module of the software program. Furthermore, if the analyzing module 113 determines that a second component data corresponding to the first component data of the first source file data 101 does not exist in the second source file data 103, or the second component data corresponding to the first component data of the first source file data 101 does exist in the second source file data 103 but no characteristic keyword is found within the paragraph in which the second component data resides, then the processing module 115 of the present invention automatically generates a substitute annotation data for the component module according to predetermined rules. The substitute annotation data in this embodiment may for example be “This function is not tested”.

The combining module 117 is used to combine the first annotation data of the various first component data extracted by the lookup module 111 and the second annotation data or substitute annotation data of the various second component data extracted or automatically generated by the processing module 115, thereby generating and outputting the final file data. The combining module 117 associates and combines the extracted first annotation data of the various first component data and the second annotation data or substitute annotation data of the various second component data into the same paragraph.

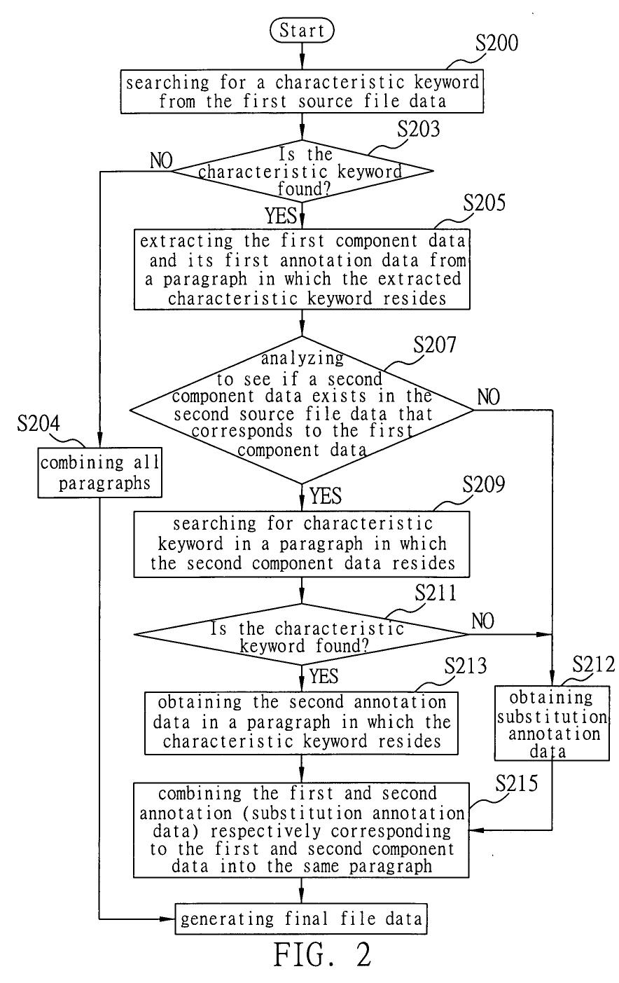

FIG. 2 is a flow chart illustrating the operating flow of a file generating method of the present invention. The file generating method of the present invention is applicable to a data processing device 100 stored with a first source file data 101 and a second source file data 103. The first source file data 101 is used for storing various first component data of a specific object (not shown), each first component data having a corresponding first annotation data. The second source file data 103 is used for storing various second component data of the specific object, each second component data having a corresponding second annotation data. In this embodiment, the specific object is a software program; the first source file data 101 are module codes of the software program, respective component parts of the software program and functional descriptions thereof are stored in the module codes; the second source file data 103 are test codes related to the software program, wherein information such as a functional test report of each component part of the software program is recorded.

As shown, first step S200 is executed, such that the lookup module 111 searches for a characteristic keyword, for example, a characteristic keyword consisting of the texts “$description$” in the first source file data 101. Then, proceed to step S203.

In step S203, it is determined whether the characteristic keyword exists in the first source file data 101. If so, then proceed to step S205; else, proceed to step S204.

In step S204, the combining module 117 combines all the paragraphs in the first source file data 101 to generate final file data.

In step S205, the lookup module 111 extracts information from the paragraph in which the characteristic keyword exists, so as to obtain the relevant first component data and the first annotation data corresponding to the first component data, that is, the various component modules in the software program and their corresponding functional description data. Then, proceed to step S207.

In step S207, the analyzing module 113 analyzes whether there is a second component data in the second source file data 103 corresponding to the first component data of the first source file data 101, if so, proceed to step S209; else; proceed to step S212.

In step S209, the processing module 115 searches for the characteristic keyword in the paragraph in which the second component data determined by the analyzing module 113 is located, then proceed to step S211.

In step S211, it is determined whether the characteristic keyword is found, if so, proceed to step S213; else, proceed to step S212.

In step S212, the processing module 115 automatically generates a substitute annotation data corresponding to the second component data based on predetermined rules, in this embodiment, the substitute annotation data may for example be “This function is not tested”. Then, proceed to step S215.

In step S213, the processing module 115 extracts the information from the paragraph in which the characteristic keyword resides, so as to obtain the second annotation data corresponding to the second component data in the second source file data 103, that is, the functional test reports corresponding to various component modules of the software program.

In step S215, the combining module 117 combines the first annotation data corresponding to the various first component data and the second annotation data (substitute annotation data) corresponding to the various second component data into the same paragraph to generate final file data.

In summary of the above, the file generating method and system of the present invention automatically obtains required data from source file data by setting up characteristic keywords in the source file data, automatically combines data when determining that correlation exists between various data extracted from different source file data, and automatically generates substitution texts based on predetermined rules when required data is not found in the source file data, thereby generating final file data. This not only ensures coherency between the relevant annotations in module codes (test codes) of the software program and the software user manuals and functional test reports, but also enhances data accuracy and reduces human resources, thus increasing work efficiency.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A file generating method applicable to a data processing device stored with first source file data and second source file data, the first source file data having first component data of a specific object, each of the first component data having corresponding first annotation data, the second source file data having second component data of the specific object, each of the second component data having corresponding second annotation data, the file generating method comprising the following steps of:
(1) looking up the first component data and extracting the first annotation data corresponding to the first component data;
(2) analyzing to see if a second component data exists in the second source file data that corresponds to one of the first component data, if so, proceed to step (3); else, proceed to step (4);
(3) extracting the second annotation data from the second source file data corresponding to the second component data, then proceed to step (5); and
(4) generating a substitute annotation data for the second component data according to predetermined rules, then proceed to step (5); and
(5) combining the first annotation data extracted in step (1) and at least one of the second annotation data extracted in step (3) and the substitute annotation data generated in step (4), thereby generating final file data.

2. The file generating method of claim 1, wherein the first source file data further include a characteristic keyword for identifying the first annotation data of the first component data of the specific object.

3. The file generating method of claim 2, wherein the characteristic keyword is stored in a setting region where the first component data and the first annotation data are placed.

4. The file generating method of claim 3, further comprising a step of (6) searching for the characteristic keyword and extracting information from the setting region in which the characteristic keyword resides, so as to extract the first annotation data of the first component data from the first source file data corresponding to the characteristic keyword, or extract the second annotation data of the second component data from the second source file data corresponding to the characteristic keyword.

5. The file generating method of claim 1, wherein the first annotation data extracted and at least one of the second annotation data and the substitute annotation data are combined into a single paragraph.

6. A file generating system applicable to a data processing device stored with first source file data and second source file data, the first source file data comprising first component data of a specific object, each of the first component data having corresponding first annotation data, the second source file data comprising second component data of the specific object, each of the second component data having corresponding second annotation data, the file generating system comprising:
a lookup module for looking up the first source file data for the first component data, and extracting the first annotation data corresponding to the first component data;
an analyzing module for analyzing whether the second source file data have any second component data corresponding to the first component data extracted by the lookup module;
a processing module for extracting the second annotation data corresponding to the second component data analyzed by the analyzed module to be corresponding to the first component data; and
a combining module for combining the first annotation data extracted by the lookup module and the second annotation data extracted by the processing module, and generating final file data.

7. The file generating system of claim 6, wherein the first source file data further comprise a characteristic keyword for identifying the first annotation data of the first component data of the specific object.

8. The file generating system of claim 7, wherein the characteristic keyword is stored in a setting region where the first component data corresponding to the characteristic keyword and the first annotation data of the first component data are stored.

9. The file generating system of claim 8, wherein the lookup module searches the setting region where the characteristic keyword is stored for the first annotation data and extracts the first annotation data corresponding to the characteristic keyword.

10. The file generating system of claim 6, wherein the combining module combines the first annotation data extracted by the lookup module and the second annotation data extracted by the processing module into a single paragraph.

11. The file generating system of claim 6, wherein the processing module further generating substitute annotation data for the second component data corresponding to the extracted first component data but having no second annotation data corresponding to the first annotation data of the extracted first component data, and the combining module further combining the substitute annotation data into the final file data.
